(19) United States
(12) Patent Application Publication
(10) Pub. No.: US 2025/0130444 A1
(43) Pub. Date: Apr. 24, 2025

(54) HYBRID SPATIAL LIGHT MODULATOR

(71) Applicant: UNIVERSITY OF WASHINGTON, Seattle, WA (US)

(72) Inventors: Virat Tara, Seattle, WA (US); Anna-Wirth Singh, Seattle, WA (US); Abhi Saxena, Seattle, WA (US); Johannes Emanuel Fröch, Seattle, WA (US); Matthew S. Reynolds, Seattle, WA (US); Rui Chen, Seattle, WA (US); Arka Majumdar, Seattle, WA (US)

(73) Assignee: UNIVERSITY OF WASHINGTON, Seattle, WA (US)

(21) Appl. No.: 18/788,492

(22) Filed: Jul. 30, 2024

Related U.S. Application Data
(60) Provisional application No. 63/530,421, filed on Aug. 2, 2023.

(51) Int. Cl. G02F 1/01; G02B 6/12

(52) U.S. Cl. CPC G02F 1/011; G02B 6/12004; G02B 2006/12107; G02B 2006/12142

(57) ABSTRACT

Spatial light modulators and associated methods are described. In one embodiment, a spatial light modulator includes a photonic integrated circuit configured for emitting a plurality of light beams as a first waveform by a plurality of pixels. The light beams are individually controllable. The spatial light modulator also includes a meta-optic having a plurality of nanostructures configured for receiving the first waveform and aggregating the plurality of light beams as a second waveform at a surface of the meta-optic. The spatial light modulator also includes an aperture array configured for converting the second waveform into a third waveform, where the third waveform is smaller than the second waveform.

### CROSS-REFERENCE TO RELATED APPLICATION

This application claims the benefit of U.S. Patent Application No. 63/530,421, filed Aug. 2, 2023, the disclosure of which is hereby incorporated by reference in its entirety.

### STATEMENT OF GOVERNMENT LICENSE RIGHTS

This invention was made with government support under Grant No. DARPA-YFA Award, awarded by the Defense Advanced Research Projects Agency and Grant Nos. NSF-1640986 and NSF-2003509, awarded by the National Science Foundation and Grant No. ONR-YIP Award, awarded by the Office of Naval Research. The government has certain rights in the invention.

### BACKGROUND

Modern light projectors include systems of cascaded and bulky glass optics for imaging with minimal aberrations. While these systems generate high quality images, the improved functionality comes at the cost of increased size and weight, limiting their use for a variety of applications in which such projectors may be used.

Spatial light modulators (SLMs) may be understood as light projectors. SLMs are devices for manipulating the wavefront of free-space light, with many applications including adaptive optics, deep tissue imaging, light detection and ranging, and computer-generated holography. In some cases, such SLMs include multiple sources of light (e.g., pixels) that are controlled either individually or in several groups. However, for a large number of pixels, achieving a required pixel refresh rate remains a challenge both with respect to properly routing and executing individual control mechanisms for the pixels and also with respect to power requirements for individual controls, which generally scale up with the number of individual sources of light. Furthermore, even assuming proper control of individual pixels of the SLM, obtaining a small higher order diffraction free image of required resolution remains a challenge. Accordingly, systems and methods for producing high quality images (i.e., wavefronts of light) are still required.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, the inventive systems and methods for spatial light modulation combine energy-efficient, controllable modulators in photonic integrated circuits (PICs) with meta-optical beam aggregators and small-scale gratings to achieve low-energy, highly controllable higher order diffraction free images at high resolution. This hybrid approach can significantly improve a space-bandwidth performance (SBP) of the spatial light modulation, theoretically up to 10¹³ Hz·pixel, which is several orders of magnitude higher than the conventional technology.

SBP is defined as the number of tunable pixels (N², where N is a number of pixels in a row or column of the pixel matrix) times the refresh rate (f_{R}). In principle, a fast modulation rate of a single pixel (fₚ) alone does not guarantee a fast refresh rate f_{R} as a collective phase profile of the pixel array must be preserved all the time. In practice, either every pixel is controlled simultaneously, necessitating ˜O(N²) control signals, or pixels are controlled column-by-column using time-division-multiplexing technique, requiring ˜O(N) control signals, however, at the expense of an extra memory element at each pixel. Such memory can be intrinsic to the physical system itself, such as the inertia of liquid crystals (LCs), or provided by external components, such as an electronic latch under each pixel (active matrix). Nevertheless, f_{R}=fₚ is true only when ˜O(N²) control signals are used; more often, f_{R}=˜fₚ/N with ˜O(N) controls using the time-division multiplexing. For commercial LC-based SLMs, the SBP may be ˜10⁸ Hz·pixel with ˜10⁶ pixels and 100 Hz refresh speed. For digital micromirror devices, the SBP may be ˜10¹⁰ Hz·pixel with ˜10⁶ pixels and 10 kHz refresh speed. However, for many applications, such as adaptive optics to image through dynamic disordered media, even higher SBP is required (ideally, >˜10⁶ pixels and MHz to GHz refresh rate) to allow real-time operation.

There are multi-layered challenges in increasing the SBP. The power needed to operate an SLM is given by:

$${P}_{S L M} = η {E}_{o} {N}^{2} {f}_{R} = η {E}_{o} \cdot SBP$$

where Eₒ is the switching energy per pixel, and n is the fraction of the pixels that need to be changed between frames. From the above equation, decreasing Eₒ is necessary to ensure reasonable power consumption when increasing the SBP. Since optical modulation is a volume effect, the reduction of Eₒ requires lowering the volume of the pixels, which in turn necessitates a large change in the refractive index Δn to achieve a 2π phase shift. Even with unity-order index change (Δn˜O(1)), as is possible with non-volatile phase change materials or LCs, the propagation length still needs to be ˜λ, λ being the free-space wavelength of the light.

The need for sub-wavelength-scale pixels also comes from the field of view, given by λ²/Λ² (where Λ is the pixel pitch), beyond which aliasing effects occur. To maintain a large field of view, the pixel pitch needs to be ˜λ. Therefore, the active volume of the pixel in a large SBP SLM becomes small, ˜λ³. Obviously, it is difficult to have ˜O(N²) controls for small pixel pitch. While a crossbar signal path geometry can provide independent control at the expense of a slower refresh rate, carrying high-speed electrical signals on closely placed interconnects would still incur severe heating and crosstalk issues for the tunable pixels that have very high refresh frequency (e.g., a refresh frequency that is orders of magnitude higher than a typical time-multiplexing display that requires electrical control signals of much lower frequency of about 60 Hz.

Furthermore, to obtain the final image, an aggregation of the individual sources of light (e.g., light beams) is needed. Such aggregation may be achieved by diffractive optical elements (DOEs), which mimic the functionality of refractive systems in a more compact form factor. Meta-optics may be suitable examples of such DOEs, in which quasiperiodic arrays of resonant subwavelength optical antennas impart spatially-varying changes on a wavefront. These elements are of wavelength-scale thickness, enabling highly compact systems, while the large number of degrees of freedom in designing the subwavelength resonators has enabled unprecedented functionalities and flat implementations of lenses, holographic plates, blazed gratings, and polarization optics.

Turning attention to the PIC part of the overall SLM assembly, a hybrid approach to high SBP is achievable by spatially separating/decoupling the plane of electrical modulation from that of the final optical output. This alleviates the routing complexity and reduces the pixel crosstalk. Furthermore, the electrical modulation may be based on an array of ultra-low energy (sub-fJ/bit) integrated photonic modulators, operating at moderate to high speed (about 10 MHz to about 1 GHz). The low power consumption may be enabled by the tight confinement of light in integrated photonic waveguides.

In some embodiments, an electronic integrated circuit (EIC) flip-chip bonded on top of the PIC chip can individually control the modulators. After modulation, light couples out of the chip through a backside-emitting grating coupler array, with each grating coupler functioning as a pixel of the SLM. Next, although these light beams are spaced relatively far apart from each other when being emitted from the grating coupler array of the PIC, the beams can be aggregated using static meta-optics to a much tighter effective pitch having a sub-wavelength spacing. Next, the meta-optics may further route the light beams onto an aperture array that includes a system of slots or holes to produce a final composite image. The modulated light beams then out-couple with a grating coupler array, which can produce either Gaussian or uniform beams of high quality. In some embodiments, amplitude and/or phase modulation may be achieved through appropriate controls of pixels of the PIC by exploiting refractive index modulation methods like thermo-optic effect, electro-optic effect, free-carrier plasma dispersion etc.

As a result, the benefits of PICs (ultra-low energy and high-speed modulation) and meta-optics (compact free-space control of light) are combined in one system, resulting in high resolution image being projected onto a target.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 is an isometric view of a hybrid spatial light modulator in accordance with embodiments of the present technology;

FIG. 2 is a partially schematic view of a photonic integrated circuits (PIC) in accordance with embodiments of the present technology;

FIG. 3 is a partially schematic view of a PIC pixel in accordance with embodiments of the present technology;

FIG. 4 is a partially schematic view of a PIC pixel coupled with a pixel control of an electrical integrated circuit (EIC) in accordance with embodiments of the present technology;

FIG. 5 is a scanning electron micrograph image of a meta-optic in accordance with an embodiment of the present technology;

FIGS. 6A-6C illustrate several views of meta-optic's nanoposts in accordance with embodiments of the present technology;

FIGS. 7A and 7B show experimental results of measured beam pattern without and with the meta-optic, respectively in accordance with embodiments of the present technology;

FIG. 7C is a microscope image of the fabricated meta-optic acting as a beam aggregator in accordance with embodiments of the present technology; and

FIGS. 8A and 8B show experimental results of light beams that are controlled by the modulating the pixels using the EIC in accordance with embodiments of the present technology.

### DETAILED DESCRIPTION

Disclosed herein are spatial light modulators (SLMs) that are configured for manipulating the wavefront of free-space light. The inventive SLMs reduce power consumption, mutual crosstalk, and complexity of control signal wiring, while producing sharp wavefront with high resolution. In some embodiments, the SLMs combine energy-efficient modulators in (PICs) with a meta-optical beam aggregator.

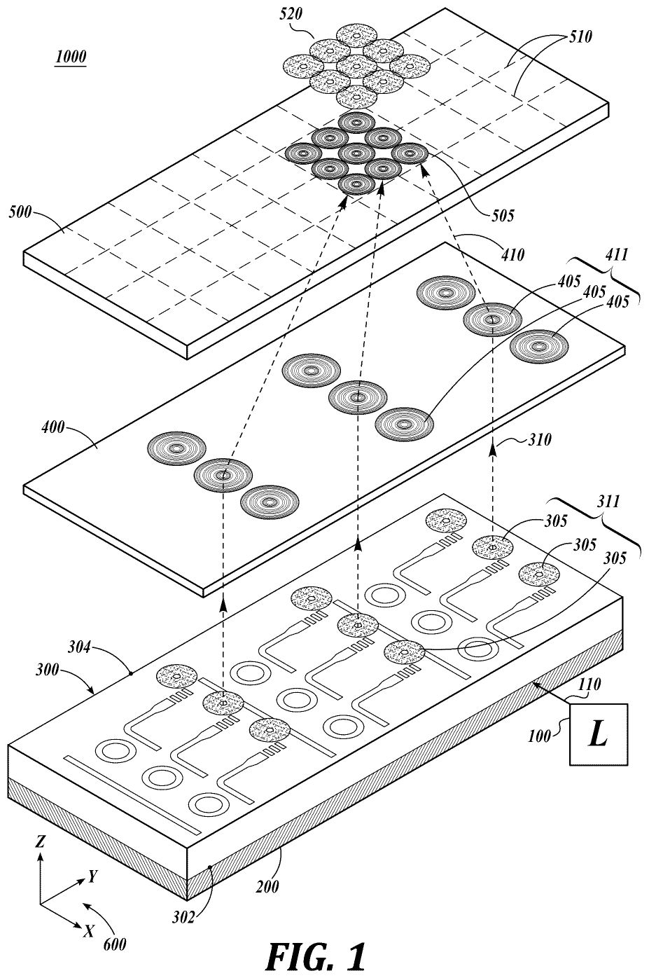

FIG. 1 is an isometric view of a hybrid spatial light modulator 1000 in accordance with embodiments of the present technology. In some embodiments, the hybrid spatial light modulator 1000 includes a source of light 100 (e.g., a laser or a light emitting diode (LED)), an electrical integrated circuit (EIC) 200 coupled with a photonic integrated circuit (PIC) 300, a meta-optic 400, and an aperture array 500. In operation, the source of light 100 generates incoming light beam 110 that is fed to a top side 302 of the PIC 300 through, for example, a network of optical conductors (fibers or optical waveguides). Individual pixels of the PIC 300 produce wavefronts 305 that form a first waveform 311. These wavefronts 305 propagate as beams 310 from the bottom side 304 of the PIC toward the meta-optic 400.

In some embodiments, the meta-optic 400 modifies the incoming light beams into wavefronts 405 that are further directed to the optical grating 500. Light beams 410 produced by the meta-optic 400 constitute a second waveform 411 at a surface of the meta-optic 400. Next, light beams 410 are focused-onto and aggregated-over a smaller area of the optical grating 500, thus increasing density of the light beams 410 as they propagate toward the optical grating 500. This is manifested as the wavefronts 505 on the aperture array 500 being more aggregated or denser than the corresponding wavefronts 405 on the meta-optic 400, while preserving the initial resolution of the image. In some embodiments, the aperture array 500 may include metallic apertures that are distributed as holes or slots 510 over a transparent substrate. A person of ordinary skill would know how to select a size of the aperture as a function of the wavelength of the light. The aperture array 500 further direct wavefronts 505 (which are now more densely aggregated than the corresponding wavefronts 405) into a composite waveform 520 (also referred to as a third waveform) that may be an image used for, for example, light detection and ranging (LIDAR) systems, holograms, or other applications that require high resolution, high dynamic image over small area.

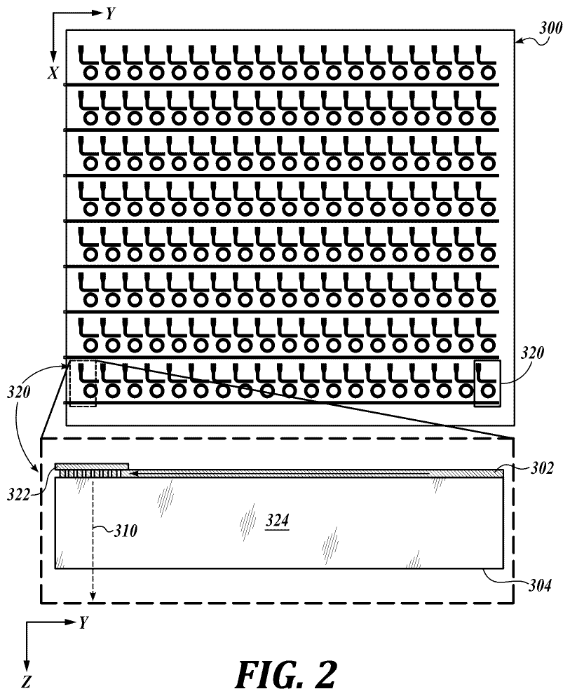

FIG. 2 is a partially schematic view of a photonic integrated circuits (PIC) in accordance with embodiments of the present technology. In particular, FIG. 2 shows a top view of the PIC 300 in the X-Y plane in the upper part of the drawing, and a detail side view of one pixel 320 of the PIC in the Y-Z plane in the lower part of the drawing. In some embodiments, pixels 320 are distributed in a 2D rectangular array of the PIC 300, but other arrangements and designs of the pixels 320 are also possible.

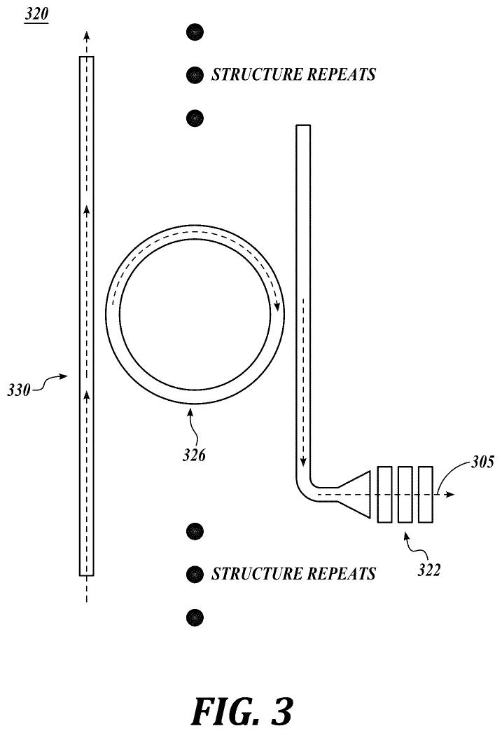

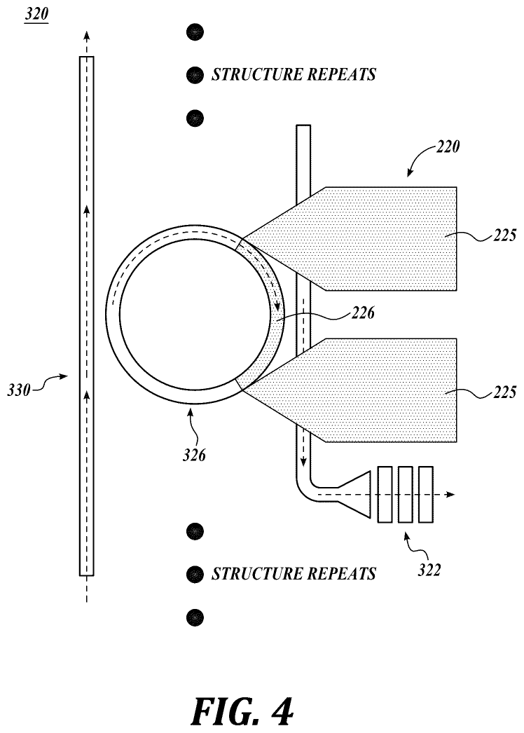

In some embodiments, pixels 320 are distributed over a transparent substrate 324. The incoming light signal couples with the pixels 320 at the top side 302 of the PIC, and the outgoing light beam 310 is emitted by a grating coupler 322 at the top side 302 of the PIC through the bottom side 304 of the PIC, as further explained with respect to FIGS. 3 and 4 below.

FIG. 3 is a partially schematic view of a PIC pixel in accordance with embodiments of the present technology. One pixel 320 is illustrated for simplicity and clarity, however the PIC 300 generally includes many more pixels.

Propagation of light signal in the pixel 320 is symbolically marked with arrows. In some embodiments, the pixel 320 (also referred to as a ring resonator modulator) includes an optical conductor (fiber or optical waveguide) 330 for distributing the incoming light beam emitted by the source of light (e.g., by a laser or an LED). This incoming light beam in the optical conductor 330 couples with a modulating ring 326, and further with a grating coupler 322. The outgoing wavefront of light (e.g., the wavefront 305) is emitted by the grating coupler 322 toward the meta-optic 400. The illustrated pixel 320 should be understood as one possible embodiment of the light-emitting pixel, other designs of the pixels that receive an incoming signal from a source of light and propagate the signal toward the meta-optic also being possible. An embodiment of amplitude/phase modulation of the waveform at the pixel 320 is explained with respect to FIG. 4 below.

FIG. 4 is a partially schematic view of a PIC pixel coupled with a pixel control of the EIC in accordance with embodiments of the present technology. FIG. 4 illustrates the pixel 320 shown in FIG. 3 where operation of the pixel 320 is controlled by a pixel control 220. In some embodiments, the EIC may include a set of conductors carried by a substrate, where the conductors of the EIC enable individual control of the modulating rings 326. In different embodiments, the pixel control 220 may be based on: electrical current passed through the electrodes 225 and active element 226, electromagnetic field produced by the electrodes and active element, thermodynamic effects over the modulating ring 326 (e.g., microheating), and/or other mechanisms of interaction between the pixel control 220 and the modulating ring 326. In operation, the pixel control 220 can affect the amplitude and/or the phase of the light wavefront emitted by the grating coupler 322. For example, the amplitude of the light wavefront may be significantly or entirely reduced, or the phase of the light wavefront may be changed with respect to the light wavefronts emitted by other PIC pixels 320 (not shown).

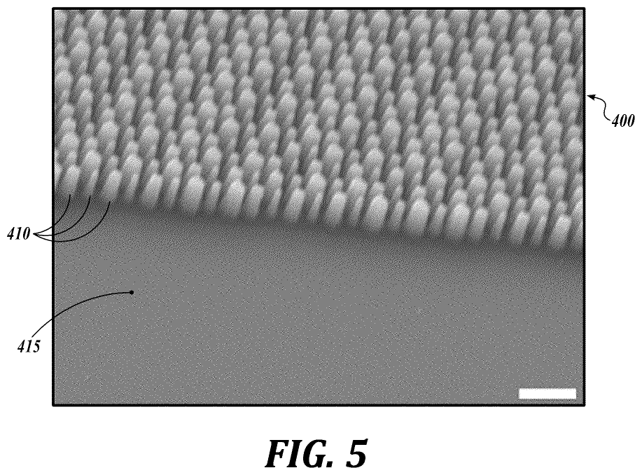

FIG. 5 is a scanning electron micrograph image of a meta-optic in accordance with an embodiment of the present technology. Illustrated meta-optic 400 includes a number of nanostructures (also referred to as “nanoposts” or “scatterers”) 410 that are carried by a substrate (also referred to as a “carrier”) 415. The nanostructures 410 may be nanoscale structures that are generally cylindrical and characterized by one or more characteristic scales (e.g., cylinder diameter d). In some embodiments, the nanostructures 420 may have different sizes, as illustrated in FIG. 1. In different embodiments, the meta-optic 400 may be manufactured by the process described below.

In some embodiments, during the manufacturing of the meta-optic 400, a 600 nm layer of silicon nitride is first deposited via plasma-enhanced chemical vapor deposition (PECVD) on a quartz substrate, followed by spin-coating with a high-performance positive electron beam resist (e.g., ZEP-520A). An 8 nm Au/Pd charge dissipation layer is then sputtered followed by subsequent exposure to an electron-beam lithography system (e.g., JEOL JBX6300FS). The Au/Pd layer may then be removed with a thin film etchant (e.g., type TFA gold etchant), and the samples may be developed in amyl acetate. In some embodiments, to form an etch mask, 50 nm of aluminum oxide is evaporated and lifted off via sonication in methylene chloride, acetone, and isopropyl alcohol. The samples are then dry etched using a CHF3 and SF6 chemistry and the aluminum oxide is removed by immersion in AD-10 photoresist developer.

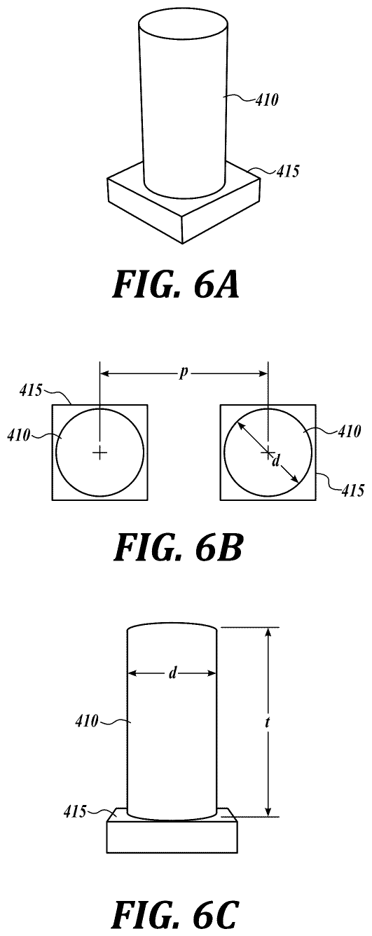

FIGS. 6A-6C illustrate several views of meta-optic′ nanoposts in accordance with embodiments of the present technology. FIG. 6A is an isometric view of a nanopost (nanostructure) 420 that is carried by a substrate 415. The illustrated nanopost 420 is cylindrical, but in other embodiments the nanopost 420 may have other shapes, for example, an elliptical cross-section, a square cross-section, a rectangular cross-section or other cross-sectional shape that maintain center-to-center spacing at a sub-wavelength value. FIG. 6B is a top view of two adjacent nanoposts that are separated by a distance “p” (pitch). Only two nanoposts are illustrated in FIG. 6B for simplicity. However, for a practical meta-optic 400, many more nanoposts are distributed over substrate 415. FIG. 6C is a side view of a nanopost 420 that is carried by a substrate 415. In some embodiments, the nanoposts (scatterers) 420 are made of silicon nitride due to its broad transparency window and CMOS compatibility.

The illustrated nanoposts 420 are characterized by a height “t” and diameter “d”. In some embodiments, the values of “d” may range from about 80 nm to about 300 nm. Generally, the value of “t” (height) is constant (within the limits of manufacturing tolerance) for all diameters “d” for a given meta-optic. In some embodiments, the values of “t” may range from about 500 nm to about 1.5 μm. The nanoposts (scatterers) may be polarization-insensitive cylindrical nanoposts 110 arranged in a square lattice on a quartz substrate 415. The phase shift mechanism of these nanoposts arises from an ensemble of oscillating modes within the nanoposts that couple amongst themselves at the top and bottom interfaces of the post. By adjusting the diameter “d” of the nanoposts, the modal composition varies, modifying the transmission amplitude and/or phase through the nanoposts.

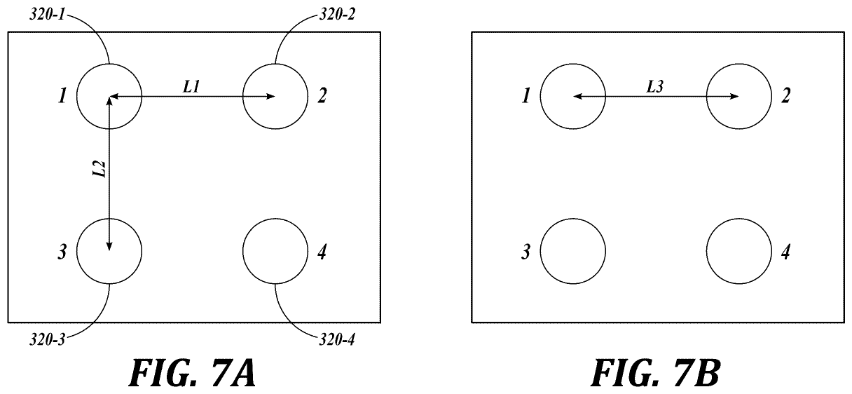

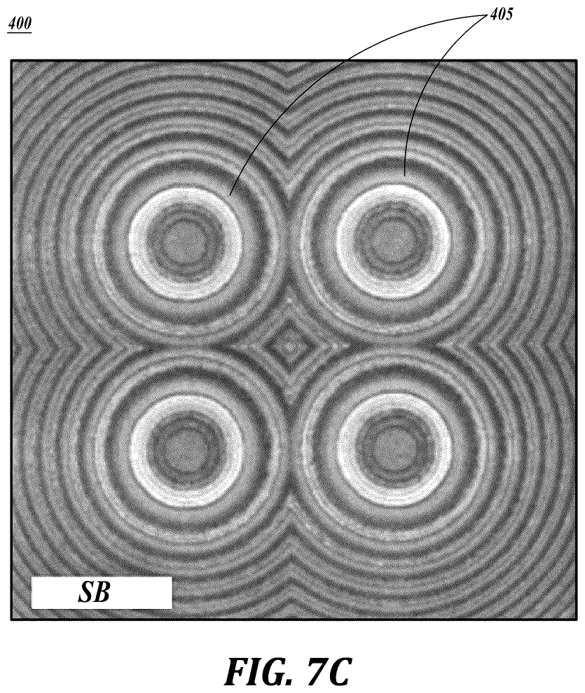

FIGS. 7A and 7B show experimental results of a measured beam pattern without and with the meta-optic, respectively, in accordance with the embodiments of the present technology. The beam pattern shown in FIG. 7A was obtained without the meta-optic 400 at the pixels 1-4 (also enumerated as 320-1 to 320-4) at the top side 302 of the PIC 300. Distance between pixels 1 and 2 is L1, and distance between pixels 1 and 3 is L2. In some embodiments, L1 and L2 correspond to about 100 μm.

The beam pattern shown in FIG. 7B was obtained after the light passes through the meta-optic 400 at about the Z coordinate where the light beams impinge onto the optical grating 500. At this point, the meta-optic has directed the light beams into a more dense aggregation of the waveform, resulting in a characteristic distance L3 between the adjacent beams of about 12.5 μm. L3 can further be reduced to a point where the beams essentially overlap with each other depending upon where the beams are being imaged at. Thus, in at least some embodiments, use of the meta-optic produces smaller images while preserving their original resolution.

A person of ordinary skill would understand that distances L1, L2, L3, etc., are provided as examples and other values are also possible, the important point being that the distances between the light beams after the meta-optic 400 is used (i.e., the case illustrated in FIG. 7B) are significantly smaller than the distances between the light beams when the meta-optic 400 is not used (i.e., the case illustrated in FIG. 7A). In some embodiments, the distances between the light beams when the meta-optic is used may be about an order of magnitude smaller than the distances between the corresponding light beams when the meta-optic is not used.

FIG. 7C is a microscope image of the fabricated meta-optics acting as a beam aggregator in accordance with embodiments of the present technology. The scale bar SB in the lower left part of the image is 50 μm long. The meta-optics 400 is designed to steer and focus light from the PIC grating couplers 322 to the desired final spacing. In some embodiments, the meta-optic phase profile φ_{MO} includes a steering phase φ_{S} plus a lensing phase φ_{L}, given by:

$$\{ \begin{matrix}{φ}_{S} = k \cdot x \cdot sin ( {θ}_{x} ) + k \cdot y \cdot sin ( {θ}_{y} ) \\ {φ}_{L} = - k \cdot ( \sqrt{{f}^{2} + {x}^{2} + {y}^{2}} - f )\end{matrix}$$

where x and y are coordinates on each lens,

$$k = \frac{2 π}{λ}$$

is the wavenumber, θₓ and θ_{y} are the desired steering angles in the x and y directions, and f is the focal length. As a result, the PIC emits light where individual beams can be phase and amplitude controlled.

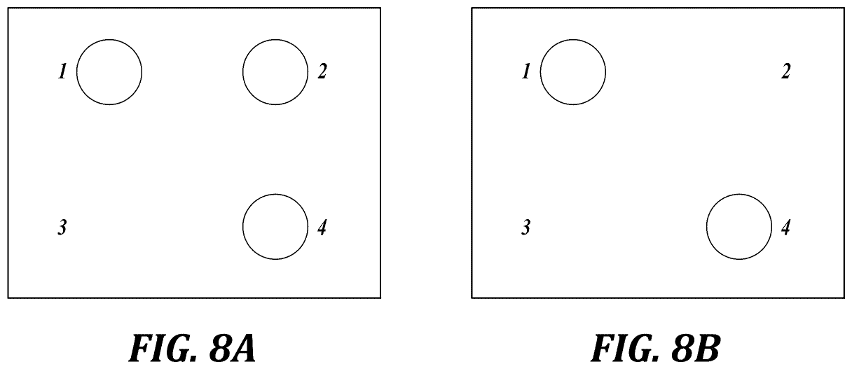

FIGS. 8A and 8B show experimental results of light beams that are controlled by the pixel controls 220 of the EIC 200 in accordance with embodiments of the present technology. FIG. 8A shows one light beam (light beam 3) that is turned off by applying electrical signals to the metallic microheaters. FIG. 8B shows two light beams (light beams 2 and 3) that are turned off by applying electrical signals to the metallic microheaters. This shows that each pixel of the PIC can be controlled independently by the corresponding structure of the EIC. While these examples show turning the light beams ON and OFF, as explained above the pixel controls 220 (e.g., microheaters) of the EIC are also capable of the amplitude/phase modulation of the light beams.

It should be noted that for purposes of this disclosure, terminology such as “upper,” “lower,” “vertical,” “horizontal,” “inwardly,” “outwardly,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. The term “about” means plus or minus 5% of the stated value.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

While illustrative embodiments have been illustrated and described, it will be appreciated that various changes can be made therein without departing from the spirit and scope of the invention.

What is claimed is:

1. A spatial light modulator, comprising:
a photonic integrated circuit configured for emitting a plurality of light beams as a first waveform by a plurality of pixels, wherein light beams are individually controllable;
a meta-optic comprising a plurality of nanostructures configured for receiving the first waveform and aggregating the plurality of light beams as a second waveform at a surface of the meta-optic; and
an aperture array configured for converting the second waveform into a third waveform, wherein the third waveform is smaller than the third waveform.

2. The spatial light modulator of claim 1, wherein the plurality of nanostructures are manufactured on a nanometer scale.

3. The spatial light modulator of claim 1, wherein the plurality of nanostructures are distributed on a substrate.

4. The spatial light modulator of claim 1, wherein each pixel of the plurality of the pixels comprises:
an optical conductor configured for transmitting incoming light;
a modulating ring configured for optically coupling with the optical conductor; and
a grating coupler configured for emitting a light beam out of the photonic integrated circuit.

5. The spatial light modulator of claim 4, wherein the optical conductor, the modulating ring, and the grating coupler are configured at a top side of the photonic integrated circuit, and wherein the grating coupler is configured for emitting the light beam out of the photonic integrated circuit through a bottom side of the photonic integrated circuit.

6. The spatial light modulator of claim 4, further comprising an electrical integrated circuit comprising a plurality of pixel controls configured for controlling the plurality of light beams.

7. The spatial light modulator of claim 6, wherein each pixel control is configured for controlling an amplitude and a phase of corresponding light beam of the plurality of light beams.

8. The spatial light modulator of claim 6, wherein each pixel control comprises a pair of electrodes and an active element, and wherein the active element is configured proximate to the modulating ring.

9. The spatial light modulator of claim 8, wherein the plurality of pixel controls control the plurality of pixels is based on at least one of:
electrical current passed through the electrodes and the active element;
electromagnetic field produced by the electrodes and the active element; or
microheating over the modulating ring.

10. The spatial light modulator of claim 1, wherein the first waveform, the second waveform and the third waveform have a same resolution.

2. A method of generating an image by a spatial light modulator, the method comprising:
emitting a plurality of light beams as a first waveform by a plurality of pixels of a photonic integrated circuit, wherein light beams are individually controllable;
aggregating the plurality of light beams as a second waveform on a surface of a meta-optic, wherein the meta-optic comprises a plurality of nanostructures; and
converting the second waveform into a third waveform by an aperture array, wherein the third waveform is smaller than the second waveform.

12. The method of claim 11, wherein the first waveform, the second waveform and the third waveform have a same resolution.

13. The method of claim 11, the plurality of nanostructures are manufactured on a nanometer scale.

14. The method of claim 11, wherein the plurality of nanostructures are distributed on a substrate.

15. The method of claim 11, wherein each pixel of the plurality of the pixels comprises:
an optical conductor configured for transmitting incoming light;
a modulating ring configured for optically coupling with the optical conductor; and
a grating coupler configured for emitting a light beam out of the photonic integrated circuit.

16. The method of claim 15, wherein the optical conductor, the modulating ring, and the grating coupler are configured at a top side of the photonic integrated circuit, and wherein the grating coupler is configured for emitting the light beam out of the photonic integrated circuit through a bottom side of the photonic integrated circuit.

17. The method of claim 15, further comprising controlling the plurality of light beams by a plurality of pixel controls of an electrical integrated circuit.

18. The method of claim 17, wherein each pixel control is configured for controlling an amplitude and a phase of corresponding light beam of the plurality of light beams.

19. The method of claim 17, wherein each pixel control comprises a pair of electrodes and an active element, and wherein the active element is configured proximate to the modulating ring.

20. The method of claim 18, wherein controlling the amplitude and the phase of corresponding light beam comprises:
controlling electrical current passed through the electrodes and the active element;
controlling electromagnetic field produced by the electrodes and the active element; or
controlling microheating of the modulating ring.
